(19) United States
(12) Patent Application Publication
(10) Pub. No.: US 2013/0282596 A1
(43) Pub. Date: Oct. 24, 2013

(54) SYSTEMS AND METHODS FOR EVALUATING PROPERTY VALUATIONS

(71) Applicant: Mark M. Fleming, Vienna, VA (US)

(72) Inventor: Mark M. Fleming, Vienna, VA (US)

(73) Assignee: CORELOGIC SOLUTIONS, LLC, Santa Ana, CA (US)

(21) Appl. No.: 13/454,942

(22) Filed: Apr. 24, 2012

(51) Int. Cl. G06Q 50/16

(52) U.S. Cl. 705/306

(57) ABSTRACT

Systems and methods are disclosed for evaluating a property valuation. In some implementations, market information and transactional information for a group of properties is accessed. The market information can include property-specific factors, locational factors, and market sales factors. The transactional information can include exogenous factors that can influence a property evaluator. Statistical information relating to the market values of the properties and the property valuations can be calculated. An estimate of the degree of certainty for a property valuation can be determined based at least partly on the calculated statistical information.

### BACKGROUND

1. Field

The present disclosure relates to systems and methods for evaluating a property valuation such as an appraisal of the property.

2. Description of the Related Art

In a real estate transaction, it is common to obtain an appraisal of a property prior to completion of the real estate transaction. The appraisal can provide a valuation for the property that attempts to estimate the true or fair market value of the property. Since the property may secure a loan used to purchase or finance the property, a financial entity (such as a lender, bank, or mortgage broker) may choose to order an appraisal as part of the loan application process. Appraisals can be performed, for example, in-person, in which a property evaluator physically inspects the property (and surrounding area) or by determining an appraisal value based on sale prices of comparable properties. The financial entity can use the appraisal value, in combination with the proposed sales price and other information, to determine whether or not to make the loan to a purchaser or financer.

### SUMMARY

While an appraisal may provide a range of prices for comparable sales used to develop the appraised value, the appraisal generally does not provide sufficient data to establish a valid reasonable price range or confidence score for the property valuation. The present disclosure provides examples of systems and methods that can estimate the certainty of a property valuation or a reasonable price range for a property based, at least partly, on observable transaction-level information and market-level information.

In one aspect, a method for evaluating a property valuation performed by a property evaluator is provided. The method comprises accessing, by a physical computing system, market information for a plurality of properties in a market area. The market information can comprise one or more of: (i) property-specific factors relating to individual properties in the market area, (ii) locational factors relating to the location of individual properties in the market area, and/or (iii) market sales factors relating to market dynamics for the plurality of properties. The method further includes accessing, by the physical computing system, transactional information for the plurality of properties, the transactional information comprising one or more factors indicative of exogenous influences on the property evaluator. The exogenous influences do not include the property-specific factors, the locational factors, or the market sales factors. The method further includes calculating, by the physical computing system, based at least in part on the market information, market statistical information relating to the market values of the plurality of properties, and calculating, by the physical computing system, predicted market values for one or more of the plurality of properties. The method also includes calculating, by the physical computing system, based at least in part on the transactional information, the market statistical information, and the predicted market values, transactional statistical information relating to the exogenous influencing factors. The method also includes determining, by the physical computing system, based at least in part on the market statistical information and the transactional statistical information, a measure of certainty for a property valuation of one of the plurality of properties.

In another aspect, a system for evaluating a valuation of a property performed by a property evaluator is provided. The system comprises physical data storage configured to store (1) market information for a plurality of properties in a market area and (2) transactional information for the plurality of properties. The market information can comprise one or more of: (i) property-specific factors relating to individual properties in the market area, (ii) locational factors relating to the location of individual properties in the market area, and (iii) market sales factors relating to market dynamics for the plurality of properties. The transactional information can comprise one or more factors indicative of exogenous influences on the property evaluator. The exogenous influences do not include the property-specific factors, the locational factors, or the market sales factors. The system can also include a computer system in communication with the physical data storage. The computer system can comprises computer hardware and be programmed to calculate, based at least in part on the market information, market statistical information relating to the market values of the plurality of properties. The computer system can also be programmed to calculate, based at least in part on the transactional information and the market statistical information, transactional statistical information relating to the exogenous influencing factors. The computer system can also be programmed to determine, based at least in part on the market statistical information and the transactional statistical information, a measure of certainty for a valuation of a property. The computer system can also be programmed to provide the measure of certainty for the valuation of the property.

In another aspect, a system for evaluating a valuation of a property performed by a property evaluator is provided. The system comprises physical data storage configured to store (1) market statistical information for a plurality of properties in a market area and (2) transactional statistical information for the plurality of properties. The market statistical information can be based at least in part on one or more of: (i) property-specific factors relating to individual properties in the market area, (ii) locational factors relating to the location of individual properties in the market area, and (iii) market sales factors relating to market dynamics for the plurality of properties. The transactional statistical information can be based at least in part on one or more factors indicative of exogenous influences on the property evaluator. The system can also include a computer system (which can include computer hardware) in communication with the physical data storage. The computer system can be programmed to access a valuation performed by the property evaluator for a property and determine, based at least in part on the market statistical information and the transactional statistical information, a measure of certainty for the valuation of the property. The computer system can also be programmed to provide the measure of certainty for the valuation of the property.

Details of one or more implementations of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 is a graph that illustrates an example of a probability distribution for possible valuations for a property. The mean of the probability distribution is $330,000 and the standard deviation of the probability distribution is $10,000.

FIG. 2 is a block diagram that schematically illustrates an implementation of a system for evaluating appraisals.

FIG. 3 schematically illustrates an example of a system flow diagram for determining the accuracy of property valuations.

FIG. 4 is a flowchart that illustrates an example method for providing statistical information about property valuations such as appraisals.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

### Overview

An automated valuation model (AVM) can be used to calculate a reasonable market value for a real estate property. The AVM may be associated with a confidence score (e.g., a forecast standard deviation (FSD)) that indicates the accuracy of the calculated market value. The confidence score provides information about how much the AVM vendor believes the actual value could vary from the AVM valuation. When using an AVM, financial entities may look at both the valuation returned by the AVM as well as the confidence score to determine whether the returned valuation is likely to be accurate of the true or fair market value (FMV) of the property. For example, many financial entities set minimum thresholds for confidence scores and will not accept AVM valuations that do not meet or exceed these criteria. If the level of uncertainty around a valuation is too high, the financial entity may choose not to use the AVM valuation and instead order an appraisal of the property by a property evaluator. For example, the property evaluator may perform the appraisal by physically visiting the property (e.g., an in-person appraisal) or by using information on comparable sales in the area (“comps”). Property evaluators can include appraisers, real estate agents or brokers, surveyors, or other persons or entities who are engaged to provide a property valuation for a property.

However, there is also a level of uncertainty in an appraisal valuation and many of the same factors that can lead to uncertainty in AVM valuations (e.g., the quality, quantity, and/or freshness of comparable sales) also can create uncertainty in appraisals performed in-person or using comparable sales. Yet such appraisals do not have confidence scores or other accuracy indicator by which a financial entity can gauge the level of uncertainty for the appraisal. Thus, when choosing to use an appraisal by a property evaluator over an AVM valuation, financial entities are trading a valuation with known certainty (the AVM) for a valuation with unknown certainty (the appraisal). Accordingly, there is a need to establish a measure of the certainty around an appraisal valuation, and the systems and methods disclosed herein can be used to provide, among other features, an estimate of the accuracy of the appraisal valuation. A financial entity may use the measure of certainty of an appraisal to evaluate, for example, whether the appraisal is of sufficiently high quality or accuracy or whether the appraisal is of sufficiently low quality that a reappraisal of the property should be ordered.

While most methods of property valuation provide a single value for a property, there is a range of values between which a property could reasonably be expected to transact in an arms-length transaction. Factors that affect this range include (1) transaction level factors such as the relative negotiating skills and motivation levels of the buyers and sellers, and (2) market level factors such as the homogeneity of the housing stock, the volume of transactions, local market price trends, and the level of distressed properties (e.g., properties under a foreclosure order or advertised for sale by a mortgagee). For example, properties with a very homogenous market and a high level of recent arms-length transactions will likely have a much narrower reasonable price range than a rural property in a market with low transaction volume and a high level of foreclosures.

Appraisals may also suffer from various biases that lead to inaccurate property valuations. Biasing influences can include an appraiser's own prior valuation opinions and undisclosed contract prices on the subject property as well as for comparable properties. Pressures of agent-client relationships, loan terms, and market dynamics can influence the behavior of the appraiser and cause the appraiser to either systematically overvalue or undervalue a property relative to its true market value. For example, as independent contractors working for a mortgage broker, there can be an incentive for an appraiser to provide appraised values that support the proposed loan amount. Alternatively, if appraisers are concerned with their credibility in a market with declining values, they may be more inclined to undervalue a property as opposed to overvalue a property in a growing market. Further, since an appraisal can use comparable sales prior to the appraisal valuation date, there may be an inherent bias in the appraisal, unless the market is neither appreciating nor depreciating or the appraiser has sufficient information to be able to accurately adjust for market trends.

While an appraisal may provide a range of prices for the comparable sales used to develop the appraised value, the appraisal generally does not provide sufficient data to establish a valid reasonable price range or confidence score for the appraisal valuation. The inventor of this application has recognized that it is possible to build a price range and a confidence score by leveraging external data sources and mathematical models. The present disclosure provides examples of analytical and numerical models that can predict the certainty and reasonable price range for a property based, at least partly, on observable transaction-level information and market-level information.

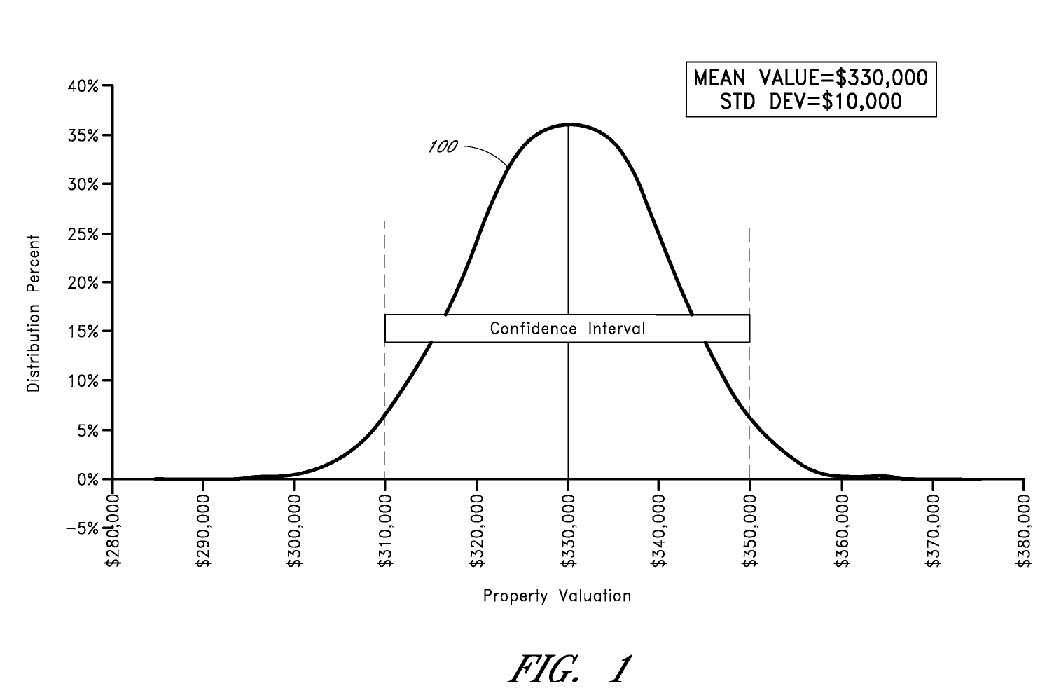

There is a range of potential values at which a property can sell, with some values more likely than others. The ability to represent the certainty of a property valuation is graphically depicted in FIG. 1, which is a graph that illustrates an example of a probability distribution for possible transaction valuations for a subject property. The horizontal axis shows values of property valuations, and the vertical axis shows the corresponding percentage of valuations at a particular value on the horizontal axis. The bell-shaped curve 100 is an example of a possible probability distribution (e.g., a Gaussian distribution) for possible property valuations. In this example, the mean of the probability distribution is $330,000, and the forecast standard deviation (FSD) of the probability distribution is $10,000. Therefore, the most likely true value for the property is $330,000. The confidence interval shows a range of likely property valuations around the most likely value (the peak of the distribution, which is at the mean value in this example). In FIG. 1, the confidence interval corresponds to two standard deviations on either side of the mean. In other examples, the confidence interval could be defined differently, such as one or three standard deviations around the mean. For the assumed standard deviation (FSD) of $10,000, it is possible to say with a high degree of certainty that the true value of the property lies within the confidence interval, that is, the true value is in a price range of $310,000-$350,000. For Gaussian probability distributions, a two standard deviation confidence interval corresponds to a degree of certainty of approximately 95%.

Embodiments of the systems and methods described herein can be used to determine a statistical estimate of the degree of certainty of an appraisal of a property. The degree of certainty can be expressed as a confidence interval (similar to the example described in FIG. 1), a standard deviation, a variance (e.g., the standard deviation squared), a confidence score, index, or ranking, or some other statistical measure of the likelihood that the appraisal accurately measures or estimates the true market value for the property. In some such embodiments, the systems and methods can utilize a range of factors associated with the property itself, the market within which the property resides, and information provided in documentation or information provided with a property valuation to determine the statistical certainty of a property valuation such as an appraisal.

In certain embodiments of the systems and methods disclosed herein, the certainty of a property valuation (such as an appraisal) can be determined in terms of the statistical variance of the valuation. An advantage of certain such embodiments is that the statistical certainty can be used to predict the likelihood of either (or both) overvaluation or undervaluation of the property. Estimates of the bias in the property valuation can be provided. Further, in various implementations, the statistical certainty of an appraisal may be determined without comparing two or more appraised values with each other, without predicating the analysis on a predefined threshold for significant overvaluation of the property, and/or without needing to use an estimation method for prediction of the likelihood of a specific event occurring (e.g., an overvaluation event). In various embodiments, the systems and methods can be applied to determine the statistical certainty of an appraisal by a property evaluator who performs an in-person appraisal of the property or who generates an appraisal based at least partly on comparable sales (“comps”). In certain embodiments, the systems and methods described herein can also be used to determine the statistical certainty of a property valuation generated by a computerized AVM or any other type of property appraisal or valuation.

### Examples of Systems for Evaluating Appraisals

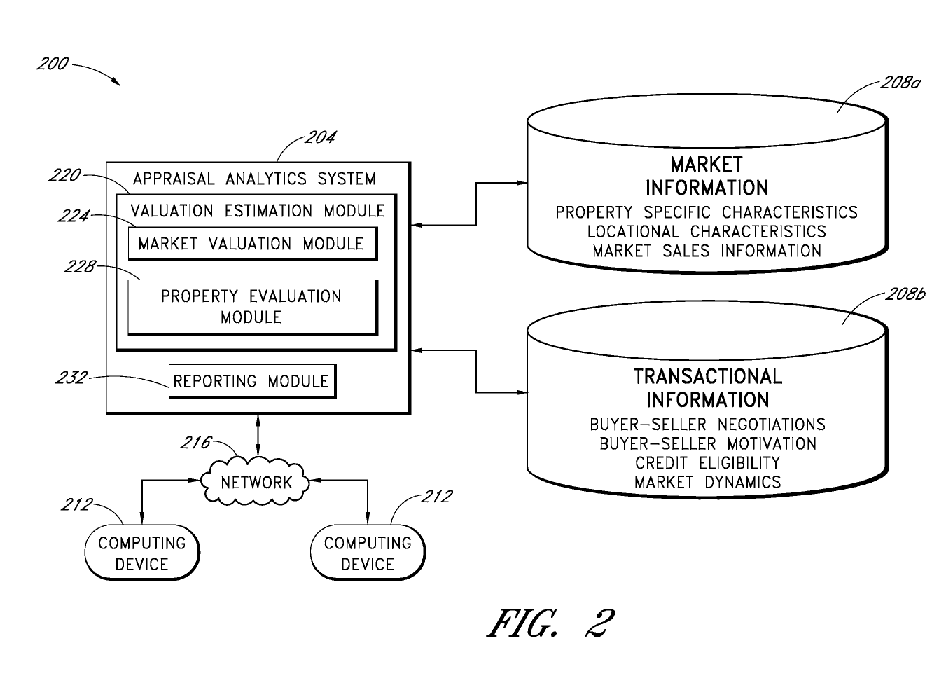

FIG. 2 is a block diagram that schematically illustrates an example implementation of a system 200 for evaluating appraisals of property. The system 200 includes an appraisal analytics system 204 that is in communication with data store 208a, which stores market information, and data store 208b, which stores transactional information. The appraisal analytics system 204 can use the market and transactional information stored on the data stores 208a, 208b to evaluate property appraisals, for example, by returning a statistical measure of the certainty of the property appraisal (e.g., a statistical variance). As will be described further below, the analytics system 204 can include a valuation estimation module 220 that calculates the statistical measure of certainty for an appraisal and a reporting module 232 that performs reporting, auditing, and other communication functions with managers and customers of the system 200.

One or more computing devices 212 may communicate with the appraisal analytics system 204 over a network 216. For example, an analytics administrator or manager can use a computing device to manage the evaluation system 200, or a customer, such as a lender or mortgage broker, can use a computing device to request or access information (e.g., the statistical variance) about a particular property appraisal. The computing devices 212 can include general purpose computers, data input devices (e.g., terminals or displays), web interfaces, portable or mobile computers, laptops, or tablets, smart phones, etc. The network 216 can provide wired or wireless communication between the computing devices 212 and the analytics system 204. In some implementations, the data stores 208a, 208b can communicate with the analytics system 204 (and/or the computing devices 212) over the network 216. The network 216 can be a local area network (LAN), a wide area network (WAN), the Internet, an intranet, combinations of the same, or the like. In certain embodiments, the network 216 can be configured to support secure shell (SSH) tunneling or other secure protocol connections for the transfer of data between the analytics system 204, the computing devices 212, and/or the data stores 208a, 208b.

The appraisal analytics system 204 can be implemented on computer hardware, such as one or more physical computer servers. The data stores 208a, 208b can be implemented on any type of computer storage medium. Although illustratively shown as separate data stores 208a and 208b in FIG. 2, the market and transactional information can be stored on any number of data stores, and the information need not be separately stored as market information or transactional information, as there may be overlap between these illustrative categories.

In the example shown in FIG. 2, the valuation estimation module 220 of the analytics system 204 includes a market valuation module 224 and a property evaluation module 228. The valuation estimation module 220 can use the market information and/or the transactional information from the data stores 208a, 208b to determine the statistical information about property appraisals.

The market information can include property specific characteristics, locational characteristics, and/or market sales characteristics. Example of property specific characteristics can include the type of property (e.g., single family residence, condominium, commercial property, etc.), characteristics of the type of property (e.g., the number of bedrooms and bathrooms for a single family residence or the number of leasable units in a commercial property, whether improvements have been made to the property, etc.), the address of the property, the quality of the property (e.g., as determined by a physical inspection), information on prior or current sale prices, appraisals or valuations, information on prior or current loans secured by the property, the nature of the loans (e.g., whether for purchase or for refinance), and so forth. Examples of locational characteristics can include information about the neighborhood or area near the property (e.g. typical dwelling type, share of commercial, multifamily, industrial, zoning classification) and proximity to externalities in the area (e.g. golf courses, parks, landfills, highways, bodies of water). Examples of market sales characteristics can include the volume of recent property transactions, homogeneity of the housing stock, property valuation trends (e.g., whether the local market is appreciating or depreciating), rates of delinquency, foreclosures, refinances, or short sales, etc. Although the foregoing description has categorized market information via property-specific, locational, or market sales characteristics, it is to be understood that this is for purposes of illustration and not limitation, and that any other categorization or organization of market information can be used in other implementations.

The transactional information can include information on the experience or capability of a property evaluator, data from the property evaluator's report on the property, the relative negotiation skills and motivation levels of the buyers and sellers, the relationships between the property evaluator, lender, buyer, and seller, credit eligibility or past history of the buyer, seller, or refinancer, etc. For example, the experience of the property evaluator can be provided as the number of years of practice for each type of property the evaluator has had experience evaluating. The capability of the property evaluator can include information whether the evaluator has experience valuing the particular type of property (e.g., residential or commercial). Such types of information may be provided to the system 200 as a Boolean value (e.g., true or false). As an example, for an evaluation of a residential property, a property evaluator with many years of experience evaluating commercial properties may be assigned an experience score or ranking that is lower than the score or ranking assigned to a property evaluator with fewer total years of experience but several years of experience evaluating residential properties. A weighted combination of years of practice, experience for particular property types, experience in particular geographic locations, etc. can be provided to the system 200.

In some implementations, certain types of transactional information can be provided to the system 200 as numerical (or Boolean) rankings, ratings, indexes, or scores. For example, a real estate agent (or property evaluator) familiar with the skills or motivation levels of buyer(s) or seller(s) of a property can provide a numerical ranking for the agent's (or evaluator's) personal estimation of buyer/seller motivation, credit eligibility, etc. (e.g., from 1 to 10, with 1 indicating low levels and 10 indicating high levels). As an example, a seller who needs to move to another state for a new job may be highly motivated to sell and assigned, for example, a motivation level of 9; whereas, a first time home buyer who may be testing the market and may have relatively low credit eligibility (e.g., due to poor or short credit history) may be assigned, for example, a motivation level of 2.

The transactional (or market) information can include some or all of the information from a Uniform Residential Appraisal Report (e.g. Fannie Mae Form 1004), a Manufactured Home Appraisal Report (e.g., Fannie Mae Form 1004C), a Market Conditions Addendum to the Appraisal Report (e.g., Fannie Mae Form 1004MC, or any other type of form or report used by property evaluators, real estate agents or brokers, etc. In some cases, the transactional information can be thought of as including exogenous factors that can influence the valuation made by a property evaluator who is performing the appraisal of the property. The transactional information may be obtained from credit history providers, real estate brokers, mortgage brokers, property evaluator reports, and so forth.

The analytics system 204 may access machine-readable versions of market or transactional information (e.g., information stored on the data stores 208a, 208b). For example, the machine-readable version can include an extensible markup language (XML) version of the fields in a property evaluator report (e.g., the Uniform Residential Appraisal Report). Numerical (or Boolean) scores, ratings, indexes, or rankings for transactional information (e.g., buyer/seller motivation) can be provided or input to the system 204. The analytics system 204 may use such information or information based on an analysis of such information as compared to public and proprietary data sources. In various implementations, the analytics system 204 can access market or transactional information directly from) ML data versions of the property evaluator reports input automatically, information input manually by an individual based on the property evaluator report or a report provided by a real estate agent, or by querying databases of historical property evaluator reports or public and proprietary databases.

In certain implementations, the market or transactional information for the properties may be categorized by geographic area (e.g., county or zip code), economic tier (e.g., price ranges), or property type (e.g., commercial or residential). The system 200 can be used to provide information about appraisals based on such categorizations. For example, estimates of the accuracy of appraisals for certain property types in a particular economic tier in a particular geographic area can be generated.

As will be further described below, in some analytics methods, the market valuation module 224 can use the market information from the data store 208a to generate statistical information about the market values of properties. The property evaluation module 228 can use the generated statistical information on market values and the transactional information from the data store 208b to generate statistical information about the appraisal values of the properties. For example, the property evaluation module 228 may calculate a statistical measure (e.g., a variance) that indicates a degree of certainty that an appraisal value is accurate. The reporting module 232 can provide or output the statistical measure to a system administrator or customer (e.g., a financial entity). For example, the reporting module 232 may provide information via electronic mail, via a web-based interface (e.g., using suitable application programming interface (API) commands), etc. The reporting module 232 may store the statistical information generated by the valuation estimation module 220 in a data store (e.g., either of the data stores 208a, 208b or some other data store) where the data can be accessed by appropriate parties. Although the appraisal analytics system 204 of FIG. 2 is shown as comprising several separate modules 220, 224, 228, and 230, this is for purposes of illustration and is not intended to limit the scope of the system 204. In other implementations, some or all of the functionality of the illustrated modules may be combined, rearranged, or left out.

### Examples of Algorithms for Determining Accuracy of Property Valuations

One possible approach to estimating the accuracy of a property valuation such as an appraisal is to compare the valuation to the market value of the property. This approach may suffer from certain disadvantages in practice. For example, the market value may only be observable when a sale transaction occurs for the property. Since property valuations are also completed in many other situations where property sales do not occur, e.g., mortgage refinances, distressed asset valuations, real estate owned (REO) value determinations, etc., this approach may not be usable in such non-purchase situations. Further, even when purchases prices are available together with property valuations, there may be biases in the valuations. For example, appraised values typically meet or exceed proposed contract prices in purchase transactions. The relative rarity of appraised values lower than the contract price indicates that a one-sided bias can exist in the appraisal. Thus, certain methods for determining the accuracy of an appraised value for non-purchase transactions may yield significant underestimates of the level of accuracy. Therefore, the present disclosure provides examples of methods that address the fact that market values are unobserved for a number of transaction types upon which one would like to predict appraisal accuracy.

In the following example appraisal analytics model, the method for evaluating a property appraisal is based at least partly on the concept that the property evaluator (e.g., an appraiser, a real estate broker or agent, etc.) determines their opinion of value, Aᵢ, based, among other factors, on the true market value of the property, Vᵢ, where i is an index that identifies a particular property. The market value of the property can be based on a variety of market factors for a market area including, for example, a set of property specific characteristics, pᵢ, locational characteristics, lᵢ, and local market sales information, mᵢ. The market factors (e.g., pᵢ, lᵢ, and mᵢ) will be collectively denoted by the vector of market characteristics xᵢ. The market factors, as discussed above, can be stored in the data store 208a (see, e.g., FIG. 1).

The property evaluator's opinion of value may also be influenced by exogenous transactional factors that influence the behavior of the property evaluator. The transactional factors can include market dynamics, agent-client relationships, credit eligibility, etc., and are collectively denoted by a vector of transaction characteristics, zᵢ. As discussed above, the transactional characteristics may be stored in the data store 208b (see, e.g., FIG. 1).

In this example appraisal analytics model, the property evaluator's opinion of value for property i at time t can be determined according to the following two equations:

Vᵢₜ=ƒ(xᵢₜ) (1)

Aᵢₜ=g(Vᵢₜ,zᵢₜ) (2)

In equations (1) and (2), the additional subscript t indicates that the values of the variables can depend on the time the property valuation is made, and the functions ƒ and g will be discussed below. This illustrative system of two simultaneous equations includes two dependent variables: market value, Vᵢₜ and the property evaluator's opinion of appraised value, Aᵢₜ. For example market value could be the observable purchase price from an arms-length market transaction, and the appraised value could be the observable opinion of value given by an appraiser for the purpose of a mortgage transaction (e.g., a purchase transaction or a refinance transaction).

The general form of the functions ƒ and g in equations (1) and (2) can be linear or non-linear in different embodiments of the appraisal analytics model. The functions ƒ and g can be chosen to represent the market and transactional characteristics representing the market and the property evaluators. In some implementations, the functional equations for the appraisal analytics model are written in the following parametric form:

γ₁₁Vᵢₜ+γ₂₁Aᵢₜ+β₁₁xᵢₜ+β₂₁zᵢₜ=εᵢ₁, (3)

γ₁₂Vᵢₜ+γ₂₂Aᵢₜ+β₁₂xᵢₜ+β₂₂zᵢₜ=εᵢ₂, (4)

where the coefficients (the γ and β parameters) can be determined via statistical methods such as regression, two-stage least squares, the method of instrumental variables, the generalized method of moments, and so forth. The right hand sides of equations (3) and (4) represent error terms. In some implementations, each of the error terms is assumed to be normally distributed with zero mean and with homoscedastic variances such that

εᵢ₁□N(0,σ₁²), and (5)

εᵢ₂□N(0,σ₂²), (6)

where σ₁ is the standard deviation (σ₁² is the variance) of the error term for equation (3) and σ₂ is the standard deviation (σ₂² is the variance) of the error term for equation (4).

In some implementations of the system of equations (3) and (4), the following parameter restrictions apply:

γ₂₁=β₁₂=₂₁=0 and γ₁₁=γ₂₂=1, (7)

and the system of equations can be expressed as

Vᵢₜ+β₁₁xᵢₜ=εᵢ₁ (8)

γ₁₂Vᵢₜ+Aᵢₜ+β₂₂zᵢₜ=εᵢ₂ (9)

In such implementations, the expected value (denoted by the function E[ ]) for a property valuation can be determined as

E[Aᵢₜ]=γ₁₂β₁₁xᵢₜ−β₂₂zᵢₜ. (10)

According to equation (10), the expected value for the property valuation is a weighted function of the market characteristics xᵢₜ (e.g., pᵢₜ, lᵢₜ, and mᵢₜ) including a bias adjustment for exogenous transactional factors zᵢₜ that can influence the property valuation. The variance (denoted by the function Var[ ]) of a property valuation can be determined as

Var[Aᵢₜ]=γ₁₂²σ₁²+2γ₁₂E[εᵢ₁εᵢ₂]+σ₂², (11)

where E[εᵢ₁εᵢ₂] is the covariance between the error terms εᵢ₁ and εᵢ₂. Therefore, in this example, the variance is property specific and depends on the covariance between the error terms, which are themselves a function of market characteristics and transactional factors. In some implementations, the error terms are assumed to be uncorrelated with each other, and the variance of a property valuation can be determined as

Var[Aᵢₜ]=γ₁₂²σ₁²+σ₂². (12)

Equation (12) can be interpreted as a parameter weighted variance of the valuation itself (γ₁₂²σ₁²) plus the variance introduced by influencing exogenous transactional factors (σ₂²). Thus, in this interpretation, the lower bound of the variance is based on the variance of value predicted by the market factors (e.g., property, locational, and market characteristics) that fundamentally drive the market value of a property. The variance of influencing transactional factors can be large or small (relative to the variance predicted by market factors) depending on how strongly the market dynamics, agent-client relationships, or credit eligibility, for example, influence the behavior of the property evaluator.

Equation (11) or (12) for the variance of the property valuation can be used as a statistical measure of certainty of the property valuation in some implementations. In other implementations, the standard deviation of the property valuation (e.g., the square root of Var[Aᵢₜ]) can be used as the statistical measure of certainty of the property valuation. In yet other implementations, other statistical properties determinable from the foregoing equations can be used, additionally or alternatively, to represent the statistical measure of certainty or upon which, the statistical measure of certainty can be at least partly based. For example, in some implementations, the skewness or kurtosis can be calculated and used, or the forecast standard deviation for the property, which can be a function of the estimated variance and the market characteristics xᵢₜ (e.g., pᵢₜ, lᵢₜ, and mᵢₜ) and exogenous transactional factors zᵢₜ, can be used. In some implementations, an appraisal accuracy score (or index) can be used to measure the accuracy of a property valuation. The appraisal accuracy score may be a function of the statistical parameters reflecting market and transactional characteristics (e.g., Γ₁, σ₂) the model parameters (e.g., the γ and β parameters), and/or market characteristics xᵢₜ (e.g., pᵢₜ, lᵢₜ, and mᵢₜ) and transactional factors zᵢₜ. For example, the appraisal accuracy score may be a weighted combination of such factors. In some cases, the appraisal accuracy score can be scaled between a lower and upper bound (e.g., between 0 and 1000 or between any other lower and upper categorical or numerical range). In some cases, the score represents a certain expected frequency of occurrence (e.g., a score greater than 900 occurs 5% of the time) or a certain level of certainty (e.g. a score of 900 indicates a forecasted standard deviation of 5%).

In some implementations, the appraisal accuracy score may be a weighted combination of the factors discussed above, which are transformed to a statistical standard score reflecting a “distance,” as measured in standard deviations, of a fiducial appraisal measure, Cᵢₜ, from the expected value of the appraisal E[Aᵢₜ]. For example, the standard score (“StandardScore”) for property, i, at time, t, can be calculated from:

StandardScoreᵢₜ=(Cᵢₜ−E[Aᵢₜ])/\sqrt{Var[Aᵢₜ]}. (13)

The fiducial appraisal measure Cᵢₜ can be provided by a user (e.g., a customer), input into the system automatically or via a user computing device, input manually by an individual, or input or determined by querying public and proprietary databases. The standard score may be further transformed to a scale between 0 and 1000 (or between any other lower and upper bounded categorical or numeric range) such that the score represents a frequency of occurrence (e.g. standard score greater than 900 occurs 5% of the time) or a certain level of certainty (e.g. a standard score of 900 indicates a forecasted standard deviation of 5%) that the fiducial appraisal measure is significantly understated or overstated relative to the expected value of the appraisal of the property.

The statistical measure of certainty of the property valuation (or any other aspects of the foregoing appraisal analytics models) can be provided or output to users (or to computer storage) by the reporting module 232 (see, e.g., FIG. 1).

The system of equations (1) and (2) (or the system of equation (8) and equation (9)) is recursive, because one of the dependent variables occurs in the other's equation but not vice versa. Under the assumption that the error terms in each equation are uncorrelated, the recursive system of equations can be estimated consistently using, for example, the ordinary least squares (OLS) method for each equation independently. In some such implementations, use of OLS for each equation in the system can be considered a simplified version of the method of two stage least squares (2SLS). Accordingly, in some implementations of the system 200 shown in FIG. 2, the market valuation module 224 is used to solve the market value equation (1) (or equation (8)) to determine unbiased estimates of market value, Vᵢₜ, as well as an estimate of the variance of the market valuation estimation, σ₁², based on observable purchase prices for a set of properties, i, at time, t (e.g., using the market information from the data store 208a). Using the set of estimates of market value for any property, i, at time, t, the property evaluation module 228 can be used to solve the property evaluation equation (2) (or equation (9)) to determine estimates of the variance of the property valuation estimation, σ₂², using the exogenous transactional information from the data store 208b. The variance can be determined from equation (12). The variance of any particular property valuation can be computed based on the vector of market characteristics, xᵢₜ, the vector of exogenous transactional characteristics, zᵢₜ, and the calculated parameters (e.g., the γ and β parameters) and variances (e.g., σ₁² and σ₂²). If the error terms in equations (1) and (2) (or the system of equations (8) and (9)) are correlated with each other, then methods of estimation for systems of equations with correlated variables can be used to solve the equations, determine the statistical estimate(s) of valuation certainty, and so forth.

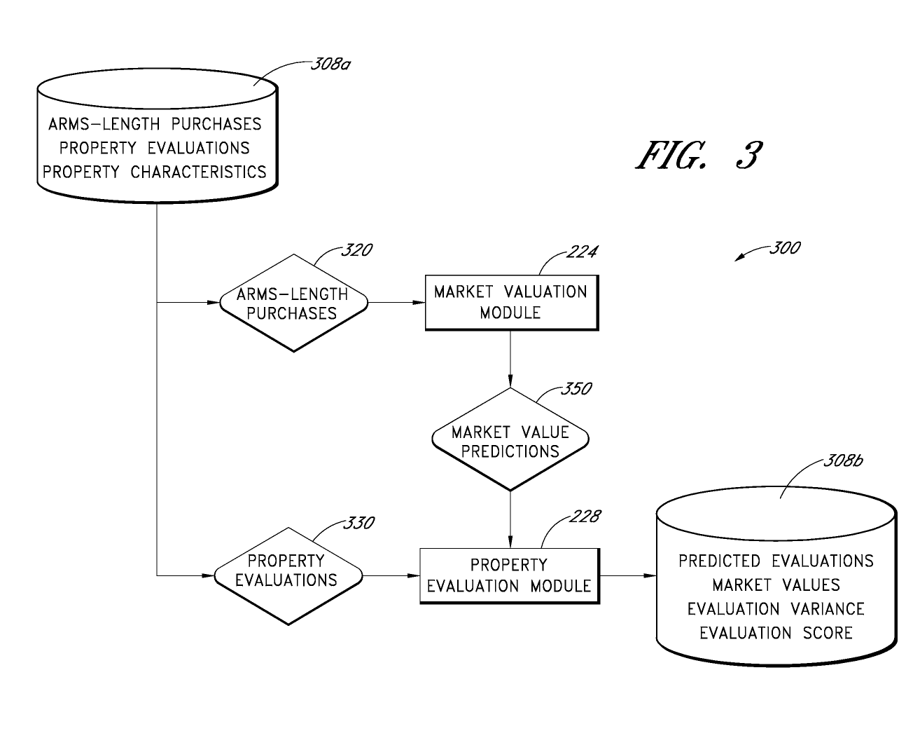

FIG. 3 schematically illustrates an example of a system flow diagram 300 for determining the accuracy of property valuations. The system flow diagram 300 can be implemented by the system 200 shown in FIG. 2. In the system flow diagram 300, market and transactional information on a variety of property transactions can be stored on a data store 308a. In some embodiments, the data store 308a can be implemented using one or more of the data stores 208a, 208b shown in FIG. 2. The property transactions can include purchases (e.g., arms-length purchases) as well as non-purchase transactions (e.g., refinances, distressed asset valuations, REO value determinations). The property transactions can also include appraisals, AVM valuations, etc. The market information can include the market characteristics xᵢ (e.g., property-specific characteristics pᵢ, locational characteristics lᵢ, and local market sales information mᵢ) for the properties. The transactional information can include the exogenous factors zᵢ that may influence a property evaluator's valuation of the properties. In certain implementations, the information for the properties may be categorized by geographic area (e.g., county or zip code), economic tier (e.g., price ranges), or property type (e.g., commercial or residential). In certain such implementations, the appraisal analytics calculations can be performed using properties in one or more of such categories. For example, market and transactional information for properties in a particular market area may be used to determine the statistical estimate of valuation certainty for a valuation of one or more properties in the market area. The market area could include a neighborhood, a development, a town or city, a county, a state, or some other area in which properties are located.

In the example system 300, the market valuation module 224 uses data on arms-length purchases 320 of properties, as well as the associated market characteristics (xᵢ) for the properties, to determine the variance, σ₁². In some embodiments, the market valuation module 224 uses ordinary least squares techniques to determine this variance. The purchase transactions 320 can also be used to estimate the other parameters of the market value equation (1) (or equation (8)). As discussed above, in various implementations, the market valuation module 224 can use OLS methods to perform these calculations.

The property characteristics for the non-purchase transactions (e.g., refinances) may then be used with the estimated parameters of the market equation to “predict” the market value 350 (e.g., Vᵢₜ) associated with a non-purchase transaction for the property i. The property evaluation module 228 can use the predicted market values 350 as well as the influencing exogenous factors, zᵢ, for the non-purchase transactions 330 to determine the transactional variance σ₂² using the property evaluation equation (2) (or equation (9)). The variance of any particular property valuation (for a purchase or non-purchase transaction) can be computed by the property evaluation module 228 from the market characteristics, xᵢₜ, the exogenous transactional characteristics, zᵢₜ, and the calculated parameters (e.g., the γ and β parameters) and variances (e.g., σ₁² and σ₂²). As discussed above, in various implementations, the property valuation module 228 can use OLS methods to perform these calculations. In other implementations, the market evaluation module 224 and/or the property evaluation module 228 can use 2SLS methods (or other statistical methods) to solve the system of equations.

The reporting module 232 can store the predicted values of the valuations, market values, and statistical measures of the accuracy or certainty of the valuations (e.g., a valuation variance or score) in a data store 308b. The reporting module 232 can also output information from the data store 308b to users or managers of the system 300.

### Examples of Methods for Determining Accuracy of Property Valuations

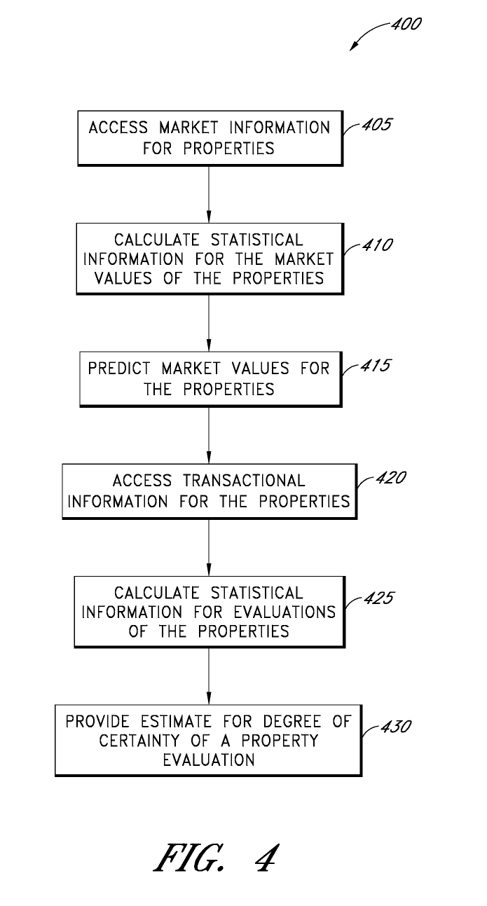

FIG. 4 is a flowchart that illustrates an example method 400 for providing statistical information about property valuations such as appraisals. The method 400 can be implemented by the system 200. At block 405, the method 400 accesses market information for a group of properties. The market information for the properties may be categorized by geographic area (e.g., county or zip code), economic tier (e.g., price ranges), or property type (e.g., commercial or residential). The market information can include property-specific characteristics pᵢ, locational characteristics lᵢ, and local market sales information mᵢ for the properties. The market information can be accessed from a data store such as the data store 208a or 308a.

At block 410, the method 400 can calculate market statistical information for the market values of the properties. In various implementations, the method 400 may calculate the market statistical information by solving one of the market equations (1), (3), or (8) using the market information accessed at block 405. In some of these implementations, information on arms-length purchase transactions is used at block 410 rather than information on non-purchase transactions. The market statistical information can include an estimate of the variance of market value estimates, σ₁². In some embodiments, the market valuation module 224 can use a regression technique (e.g., OLS or 2SLS) to calculate the market statistical information.

At block 415, the method 410 can predict market values for one or more of the properties. In some implementations, market information for non-purchase transactions (e.g., refinances) as well as the statistical information calculated at block 410 is used to determine an estimate of the market value for a property, Vᵢₜ, from one of the market value equations.

At block 420, the method 400 can access transactional information for the properties. The transactional information may be categorized by geographic area, economic tier, or property type. The transactional information can include the exogenous factors, zᵢ, that may influence a property evaluator. The transactional information can be accessed from a data store such as the data store 208b or 308a.

At block 425, the method 400 can calculate transactional statistical information for valuations of the properties. In various implementations, the method 400 may calculate the transactional statistical information by solving one of the property evaluation equations using the transactional information accessed at block 420, market statistical information calculated at block 410, and market values for properties predicted at block 415. In some of these implementations, information on non-purchase transactions is used at block 425 rather than information on purchase transactions. The transactional statistical information can include an estimate of the variance of property valuation estimates, σ₂². In some embodiments, the property evaluation module 228 can use a regression technique (e.g., OLS or 2SLS) to calculate the transactional statistical information.

At block 430, the method 400 can use the accessed market and transactional information (from blocks 405, 420) and the calculated market and transactional statistical information (from blocks 410, 425, respectively) to provide an estimate for the degree of certainty of a property valuation. As discussed herein, the degree of certainty may be a variance (see, e.g., equation (12)). The reporting module 232 can provide, output, communicate, or store the degree of certainty for a property valuation. For example, the degree of certainty (or other statistical information calculated by the method 400) may be communicated (e.g., via electronic mail, text message, short message service (SMS) or multimedia messaging service (MIMS) message, web-based application services, etc.) to a lender who wishes to have an estimate the accuracy of a property appraisal.

### CONCLUSION

Although described in the context of an appraisal analytics system, the features and methods described above can also be implemented in other environments. As one example, implementations of the disclosed systems and methods can be used to evaluate the accuracy of AVM property valuations, in addition or as an alternative to confidence scores or FSDs provided with the AVM. Additionally, some or all of the disclosed features can be used for evaluating the degree of certainty of appraisals of businesses, investments, etc.

The various illustrative logic, logical blocks, modules, and algorithm operations described in connection with the implementations disclosed herein may be implemented as electronic hardware, computer software, or combinations of both. The interchangeability of hardware and software has been described generally, in terms of functionality, and illustrated in the various illustrative components, blocks, modules, and algorithms described above. Whether such functionality is implemented in hardware or software depends upon the particular application and design constraints imposed on the overall system.

The hardware and data processing apparatus used to implement the various illustrative logic, logical blocks, modules, and algorithms described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular operations and methods may be performed by circuitry that is specific to a given function.

In one or more aspects, the methods, processes, algorithms, and functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable medium. The operations of a method or algorithm disclosed herein may be implemented in a processor-executable software module which may reside on a computer-readable medium. Computer-readable media include both nontransitory computer storage media and communication media including any medium that can be enabled to transfer a computer program from one place to another. Storage media may be any available media that may be accessed by a computer. By way of example, and not limitation, such computer-readable media may include RAM, ROM, EEPROM, CD-ROM or other optical disk storage, flash memory, magnetic disk storage or other magnetic storage devices, or any other medium that may be used to store desired program code in the form of instructions or data structures and that may be accessed by a computer. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

The systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted can be incorporated in the example methods and processes that are schematically illustrated. For example, one or more additional operations can be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for evaluating a property valuation performed by a property evaluator, the method comprising:
accessing, by a physical computing system, market information for a plurality of properties in a market area, the market information comprising one or more of: (i) property-specific factors relating to individual properties in the market area, (ii) locational factors relating to the location of individual properties in the market area, and (iii) market sales factors relating to market dynamics for the plurality of properties;
accessing, by the physical computing system, transactional information for the plurality of properties, the transactional information comprising one or more factors indicative of exogenous influences on the property evaluator, the exogenous influences not including the property-specific factors, the locational factors, or the market sales factors;
calculating, by the physical computing system, based at least in part on the market information, market statistical information relating to the market values of the plurality of properties;
calculating, by the physical computing system, predicted market values for one or more of the plurality of properties;
calculating, by the physical computing system, based at least in part on the transactional information, the market statistical information, and the predicted market values, transactional statistical information relating to the exogenous influencing factors; and
determining, by the physical computing system, based at least in part on the market statistical information and the transactional statistical information, a measure of certainty for a property valuation of one of the plurality of properties.

2. The method of claim 1, wherein the property valuation performed by the property evaluator comprises an appraisal based at least partly on a physical inspection of the property or an appraisal based at least partly on comparable sales in the market area.

3. The method of claim 1, wherein the property-specific factors for a property comprise information related to one or more of: a type for the property, purchase or non-purchase transaction prices for the property, loans on the property, improvements made to the property.

4. The method of claim 1, wherein the locational factors for a property comprise information related to one or more of: the neighborhood near the property and proximity of the property to externalities in the neighborhood.

5. The method of claim 1, wherein the market sales factors for a property comprise information related to one or more of: volume of property transactions for a stock of properties located near the property, homogeneity of the stock of properties, valuation trends for the stock of properties.

6. The method of claim 1, wherein the transactional information comprises information related to one or more of: experience or capability of the property evaluator, relative negotiation skills or motivation levels of a buyer or seller, and credit eligibility or credit history of a buyer or seller.

7. The method of claim 1, wherein calculating the market statistical information is based on market information for purchase transactions but not based on market information for non-purchase transactions.

8. The method of claim 1, wherein calculating the predicted market values is based on market information for both purchase transactions and non-purchase transactions.

9. The method of claim 1, wherein determining the measure of certainty for the property valuation comprises calculating a weighted variance based at least in part on a variance for the market statistical information and a variance for the transactional statistical information.

10. The method of claim 1, wherein determining the measure of certainty for the property valuation comprises calculating a scaled valuation score.

11. The method of claim 1, wherein determining the measure of certainty for the property valuation comprises:
accessing the property valuation for a property; and
calculating the measure of certainty for the property valuation based at least in part on the accessed property valuation, an expected value for property valuations for the plurality of properties, and a statistical measure of a width of a distribution function for the property valuations of the plurality of properties.

12. The method of claim 11, wherein the measure of certainty is determined at least in part as a function of (C−E)/σ, where C is the property valuation, E is the expected value for property valuations, and σ is a standard deviation of the distribution function.

13. A system for evaluating a valuation of a property performed by a property evaluator, the system comprising:
physical data storage configured to store (1) market information for a plurality of properties in a market area, the market information comprising one or more of: (i) property-specific factors relating to individual properties in the market area, (ii) locational factors relating to the location of individual properties in the market area, and (iii) market sales factors relating to market dynamics for the plurality of properties, and (2) transactional information for the plurality of properties, the transactional information comprising one or more factors indicative of exogenous influences on the property evaluator, the exogenous influences not including the property-specific factors, the locational factors, or the market sales factors; and
a computer system in communication with the physical data storage, the computer system comprising computer hardware, the computer system programmed to:
calculate, based at least in part on the market information, market statistical information relating to the market values of the plurality of properties;
calculate, based at least in part on the transactional information and the market statistical information, transactional statistical information relating to the exogenous influencing factors;
determine, based at least in part on the market statistical information and the transactional statistical information, a measure of certainty for a valuation of a property; and
provide the measure of certainty for the valuation of the property.

14. The system of claim 13, wherein to calculate the market statistical information and the transactional statistical information, the computer system is programmed to solve the coupled equations:
Vᵢₜ=ƒ(xᵢₜ)
Aᵢₜ=g(Vᵢₜ,zᵢₜ),
where Vᵢₜ represents the property evaluator's opinion of an appraised value Aᵢₜ for a property i at time t, xᵢₜ represents the market information for the property i at the time t, and zᵢₜ represents the transactional information property i at time t.

15. The system of claim 14, wherein the computer system is programmed to use a statistical method to solve the coupled equations.

16. The system of claim 15, wherein the statistical method comprises a two stage least squares method.

17. The system of claim 13, wherein the computer system is further programmed to:
access the valuation for the property; and
calculate the measure of certainty based at least in part on the accessed property valuation, an expected value for property valuations for the plurality of properties, and a statistical measure of a distribution function for the property valuations of the plurality of properties.

18. The system of claim 17, wherein the measure of certainty is determined at least in part as a function of (C−E)/σ, where C is the property valuation, E is the expected value for property valuations, and σ is a standard deviation of the distribution function.

19. A system for evaluating a valuation of a property performed by a property evaluator, the system comprising:
physical data storage configured to store (1) market statistical information for a plurality of properties in a market area, the market statistical information based at least in part on one or more of: (i) property-specific factors relating to individual properties in the market area, (ii) locational factors relating to the location of individual properties in the market area, and (iii) market sales factors relating to market dynamics for the plurality of properties, and (2) transactional statistical information for the plurality of properties, the transactional statistical information based at least in part on one or more factors indicative of exogenous influences on the property evaluator; and
a computer system in communication with the physical data storage, the computer system comprising computer hardware, the computer system programmed to:
access a valuation performed by the property evaluator for a property;
determine, based at least in part on the market statistical information and the transactional statistical information, a measure of certainty for the valuation of the property; and
provide the measure of certainty for the valuation of the property.

20. The system of claim 19, wherein the computer system is programmed to determine the measure of certainty for the property valuation based at least in part on the accessed property valuation, an expected value for property valuations for the plurality of properties, and a statistical measure of variability in the property valuations of the plurality of properties.

21. The system of claim 20, wherein the measure of certainty is determined at least in part as a function of (C−E)/σ, where C is the property valuation, E is the expected value for property valuations, and σ is the statistical measure of variability.

22. The system of claim 19, wherein the measure of certainty is scaled to be between an upper bound and a lower bound.
